(19) United States
(12) Patent Application Publication
(10) Pub. No.: US 2011/0224901 A1
(43) Pub. Date: Sep. 15, 2011

(54) NAVIGATION APPARATUS USED IN-VEHICLE

(76) Inventors: Sjoerd Aben, Alkmaar (NL); Erik Thomassen, Amsterdam (NL); Teun De Hass, Utrecht (NL)

(21) Appl. No.: 12/736,894

(22) PCT Filed: Oct. 8, 2008
(86) PCT No.: PCT/EP2008/063484

§ 371 Date: Jan. 25, 2011

(51) Int. Cl. G01C 21/26; B62D 15/02

(52) U.S. Cl. 701/208; 701/207; 701/200

(57) ABSTRACT

A navigation apparatus includes a processing resource that is operably coupled to a data store including digital map data. A location determination unit is also provided and capable of determining a location. In at least one embodiment, the navigation apparatus receives information from at least a vehicle: steering sensor for sensing an angular position of the vehicle steering control. Information relating to the sensed parameters is logged by the navigation apparatus while driving. Upon subsequent uploading of the information to a server, the information is analysed statistically, and combined with similar information obtained from other navigation devices. The statistical analysis enables supplementary road information to be derived, such as road lane width; Such supplementary road information is added to the digital map to facilitate greater safety awareness and route planning.

### FIELD OF THE INVENTION

The present invention relates to the field of navigation devices for in-vehicle use, and methods associated therewith. Such devices may, for example, be installed as integral vehicle equipment, or may be portable devices configured or configurable for in-vehicle use.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POls) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 920T model manufactured and supplied by TomTom International B.V., provide a reliable means for enabling users to navigate from one position to another. Such devices are of great utility when the user is not familiar with the route to the destination to which they are navigating.

As mentioned above, the memory of the PND stores map data used by the PND not only to calculate routes and provide necessary navigation instructions to users, but also to provide visual information to users through the visual display of the PND.

As is known in the art, map information can be expressed in a number of ways and indeed can comprise a number of separate information components, which are used in combination by the PND. One aspect of map information is supplementary road information to provide information additional to the mere location of the road. Supplementary road information may include information about the road surface, and lane width. In general, there are two methods for obtaining map information, including the supplementary road information. The first is to purchase the information from government authorities and original mapping companies. However, the completeness, quality and current validity of such information may not be guaranteed. The second is to drive a vehicle equipped with special mapping equipment around the road network to collect the information using the mapping equipment. For example, the road surface and lane width may be determined by dedicated mapping sensors and cameras mounted on the vehicle. However, a typical vehicle only has dedicated sensors for monitoring and aiding the performance of that vehicle, not mapping-capable measurement sensors. Equipping such vehicles with the necessary additional measurement sensors and cameras for collecting map information is expensive. Moreover, driving the special vehicles around an extensive road network to collect mapping information is time-consuming and laborious. The task is magnified when trying to prepare accurate maps covering several countries. In order to maintain the information up to date, it is necessary to send vehicles around a road network on a sufficiently frequent basis that any road and lane modifications can be detected before the existing map information becomes out of date.

It would be desirable to provide an alternative technique for collecting supplementary road information.

### SUMMARY OF THE INVENTION

The present invention is defined in the claims.

The present invention is based on the surprising appreciation that supplementary map information can be inferred by analysing statistically information generated from standard sensors of a typical vehicle. These sensors have previously been dismissed as a reliable source of mapping information, because the sensor outputs are affected by a wide variety of different driving conditions and driving events, and different vehicles use different types of sensors. However, statistical analysis to identify information patterns, can yield supplementary road information that is surprisingly accurate.

The accuracy of this technique can be enhanced by one or more of:
(a) analysing information from plural sensors of the vehicle in combination to infer information not obtainable directly from a single sensor;
(b) analysing information from plural vehicles, so that a more diverse statistical picture representing the supplementary map information can be obtained, not limited to the specific characteristics and sensors of a single vehicle;
(c) analysing information from the same vehicle making the same journey or at least passing the same point again on different occasions.

One technique of the present invention is for a navigation device used in-vehicle (either docked with a vehicle or being part of integral in-vehicle equipment) to log information obtained from the on-board vehicle sensors normally used to monitor or aid vehicle performance. The logged information is later uploaded to a server via data communications channel. The server preferably receives similar information from other navigation devices used in other vehicles. Statistical analysis of the uploaded information is used to infer accurate supplementary road information. The supplementary road information can be used to generate warnings of driving hazards, and to aid route calculations with a preference for route safety.

According to one aspect of the invention, a technique for determining physical road surface information for a road represented in a digital map, comprises:

providing a plurality of navigation devices for in-vehicle use, each navigation device being configured to store information obtained from at least a vehicle sensor selected from: a microphone; a vehicle speed sensor; a rain-fall sensor; a suspension-travel sensor; a dead-reckoning sensor; a steering sensor;

receiving the stored information from the plurality of navigation devices;

analyzing the received information statistically to determine the physical road surface information from the characteristics of the stored information from the plurality of navigation devices.

The physical road surface information may be selected from one or more of: position of pot-holes, position of speed-bumps, road surface roughness, road-surface porosity.

According to another specific aspect of the invention, a technique for determining lane width of a road, comprises:

providing a plurality of navigation devices for in-vehicle use, each navigation device being configured to store information obtained from a steering sensor of a respective vehicle representing steering of the vehicle while on the road;

receiving the stored information from the plurality of navigation devices;

analyzing the received information statistically to determine, from the characteristics of in-lane steering corrections, a value of lane width for said road.

Other aspects of the invention define independently a navigation device, a server, and methods of operation for either of these techniques, as well as a computer program element for implementing the invention using executable code.

Advantages of these embodiments are set out hereafter, and further details and features of each of these embodiments are defined in the accompanying dependent claims and elsewhere in the following detailed description.

It is thus possible to provide an apparatus and method capable of deriving supplementary road information from standard in-vehicle sensors that are not configured or intended for mapping. This simplifies the burden of collecting and updating supplementary map information, as such information can be inferred from information fed back by navigation devices to a server. The supplementary map information can be used to improve the quality and accuracy of digital maps, and enable a variety of safety advantages to be achieved when planning a route.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation device;

FIG. 2 is a schematic diagram of a communications system for communication between a navigation device and a server;

FIG. 3 is a schematic illustration of electronic components of the navigation device of FIG. 2 or any other suitable navigation device;

FIG. 4 is a schematic diagram of an arrangement of mounting and/or docking a navigation device;

FIG. 5 is a schematic diagram of a data communications bus on a schematic floorplan of a vehicle

FIG. 6 is a schematic representation of an architectural stack employed by the navigation device of FIG. 3;

FIG. 7 is a schematic representation of the functional parts of the data loging module of the application software;

FIG. 8 is a schematic plan view showing the principle of deriving lane width information from driving behaviour;

FIG. 9a is a schematic illustration of information recorded in a compressed stream;

FIG. 9b is a schematic illustration of information recorded in an information event;

FIG. 10 is a schematic plan view showing driving behaviour when encountering a pothole or speed-bump;

FIG. 11a is a schematic illustration of information recorded in a compressed stream;

FIG. 11b is a schematic illustration of information recorded in an information event;

FIG. 12a is a schematic graph showing a typical suspension travel signal when on a relatively smooth road;

FIG. 12b is a schematic graph showing a typical suspension travel signal when on a relatively rough road;

FIG. 13a is a schematic illustration of information recorded in a compressed stream;

FIG. 13b is a schematic illustration of information recorded in an information event;

FIG. 14 is a schematic illustration of the difference in the level of sensed ambient noise for porous and non-porous paved roads;

FIG. 15 is a schematic illustration of the difference in the level of sensed rain-fall for porous and non-porous roads;

FIG. 16a is a schematic illustration of information recorded in a compressed stream;

FIG. 16b is a schematic illustration of information recorded in an information event;

FIG. 17 is a schematic diagram showing information flow between multiple navigation devices and a server; and

FIG. 18 is a schematic diagram showing information flow for performing route planning using the supplementary road information.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings of the present invention are not limited to PNDs but are instead universally applicable to any type of processing device that is configured to execute navigation software in a manner configured for in-vehicle use so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention even have utility in circumstances, where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

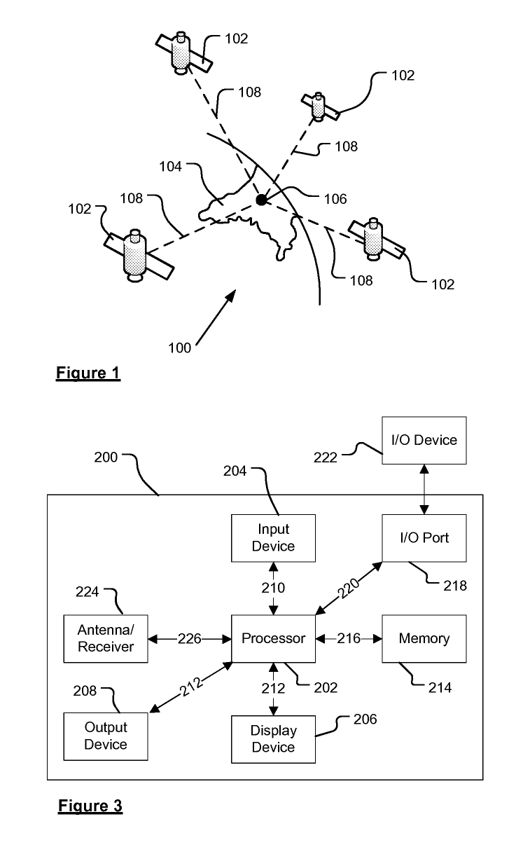

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

Turning to FIG. 2, a navigation device 200 comprising or coupled to the GPS receiver device 106, is capable of establishing a data session, if required, with network hardware of a “mobile” or telecommunications network via a mobile device (not shown), for example a mobile telephone, PDA, and/or any device with mobile telephone technology, in order to establish a digital connection, for example a digital connection via known Bluetooth technology. Thereafter, through its network service provider, the mobile device can establish a network connection (through the Internet for example) with a server 150. As such, a “mobile” network connection can be established between the navigation device 200 (which can be, and often times is, mobile as it travels alone and/or in a vehicle) and the server 150 to provide a “real-time” or at least very “up to date” gateway for information.

The establishing of the network connection between the mobile device (via a service provider) and another device such as the server 150, using the Internet for example, can be done in a known manner. In this respect, any number of appropriate data communications protocols can be employed, for example the TCP/IP layered protocol. Furthermore, the mobile device can utilize any number of communication standards such as CDMA2000, GSM, IEEE 802.11a/b/c/g/n, etc.

Hence, it can be seen that the internet connection may be utilised, which can be achieved via data connection, via a mobile phone or mobile phone technology within the navigation device 200 for example.

Although not shown, the navigation device 200 may, of course, include its own mobile telephone technology within the navigation device 200 itself (including an antenna for example, or optionally using the internal antenna of the navigation device 200). The mobile phone technology within the navigation device 200 can include internal components, and/or can include an insertable card (e.g. Subscriber Identity Module (SIM) card), complete with necessary mobile phone technology and/or an antenna for example. As such, mobile phone technology within the navigation device 200 can similarly establish a network connection between the navigation device 200 and the server 150, via the Internet for example, in a manner similar to that of any mobile device.

For telephone settings, a Bluetooth enabled navigation device may be used to work correctly with the ever changing spectrum of mobile phone models, manufacturers, etc., model/manufacturer specific settings may be stored on the navigation device 200 for example. The data stored for this information can be updated.

In FIG. 2, the navigation device 200 is depicted as being in communication with the server 150 via a generic communications channel 152 that can be implemented by any of a number of different arrangements. The communication channel 152 generically represents the propagating medium or path that connects the navigation device 200 and the server 150. The server 150 and the navigation device 200 can communicate when a connection via the communications channel 152 is established between the server 150 and the navigation device 200 (noting that such a connection can be a data connection via mobile device, a direct connection via personal computer via the internet, etc.).

The communication channel 152 is not limited to a particular communication technology. Additionally, the communication channel 152 is not limited to a single communication technology; that is, the channel 152 may include several communication links that use a variety of technology. For example, the communication channel 152 can be adapted to provide a path for electrical, optical, and/or electromagnetic communications, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

In one illustrative arrangement, the communication channel 152 includes telephone and computer networks. Furthermore, the communication channel 152 may be capable of accommodating wireless communication, for example, infrared communications, radio frequency communications, such as microwave frequency communications, etc. Additionally, the communication channel 152 can accommodate satellite communication.

The communication signals transmitted through the communication channel 152 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 152. These signals may be modulated, encrypted and/or compressed signals as may be desirable for the communication technology.

The server 150 includes, in addition to other components which may not be illustrated, a processor 154 operatively connected to a memory 156 and further operatively connected, via a wired or wireless connection 158, to a mass data storage device 160. The mass storage device 160 contains a store of navigation data and map information, and can again be a separate device from the server 150 or can be incorporated into the server 150. The processor 154 is further operatively connected to transmitter 162 and receiver 164, to transmit and receive information to and from navigation device 200 via communications channel 152. The signals sent and received may include data, communication, and/or other propagated signals. The transmitter 162 and receiver 164 may be selected or designed according to the communications requirement and communication technology used in the communication design for the navigation system 200. Further, it should be noted that the functions of transmitter 162 and receiver 164 may be combined into a single transceiver.

As mentioned above, the navigation device 200 can be arranged to communicate with the server 150 through communications channel 152, using transmitter 166 and receiver 168 to send and receive signals and/or data through the communications channel 152, noting that these devices can further be used to communicate with devices other than server 150. Further, the transmitter 166 and receiver 168 are selected or designed according to communication requirements and communication technology used in the communication design for the navigation device 200 and the functions of the transmitter 166 and receiver 168 may be combined into a single transceiver as described above in relation to FIG. 2. Of course, the navigation device 200 comprises other hardware and/or functional parts, which will be described later herein in further detail.

Software stored in server memory 156 provides instructions for the processor 154 and allows the server 150 to provide services to the navigation device 200. One service provided by the server 150 involves processing requests from the navigation device 200 and transmitting navigation data from the mass data storage 160 to the navigation device 200. Another service that can be provided by the server 150 includes processing the navigation data using various algorithms for a desired application and sending the results of these calculations to the navigation device 200. A further service that can be provided by the server 150 is the processing of information collected by the navigation device 200, as described later.

The server 150 constitutes a remote source of data accessible by the navigation device 200 via a wireless channel. The server 150 may include a network server located on a local area network (LAN), wide area network (WAN), virtual private network (VPN), etc.

The server 150 may include a personal computer such as a desktop or laptop computer, and the communication channel 152 may be a cable connected between the personal computer and the navigation device 200. Alternatively, a personal computer may be connected between the navigation device 200 and the server 150 to establish an internet connection between the server 150 and the navigation device 200.

The navigation device 200 may be provided with information from the server 150 via information downloads which may be periodically updated automatically or upon a user connecting the navigation device 200 to the server 150 and/or may be more dynamic upon a more constant or frequent connection being made between the server 150 and navigation device 200 via a wireless mobile connection device and TCP/IP connection for example. For many dynamic calculations, the processor 154 in the server 150 may be used to handle the bulk of processing needs, however, a processor (not shown in FIG. 2) of the navigation device 200 can also handle much processing and calculation, oftentimes independent of a connection to a server 150.

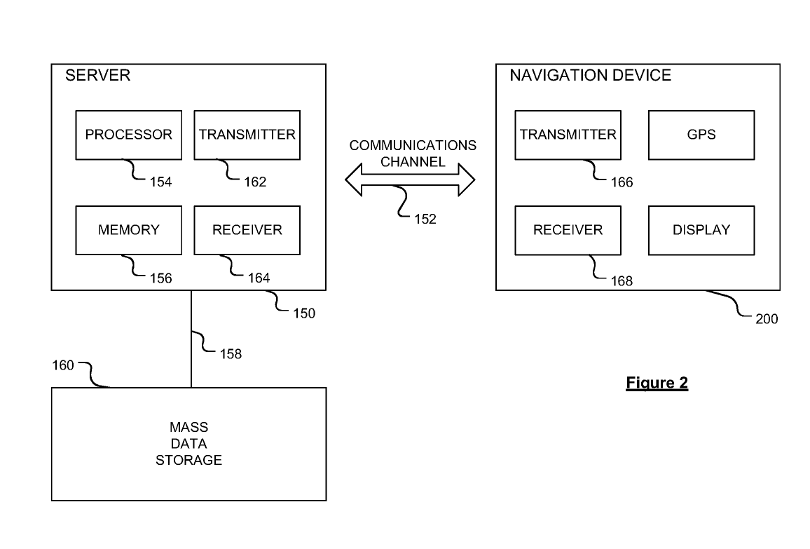

Referring to FIG. 3, it should be noted that the block diagram of the navigation device 200 is not inclusive of all components of the navigation device, but is only representative of many example components. The navigation device 200 is located within a housing (not shown). The navigation device 200 includes a processing resource comprising, for example, the processor 202 mentioned above, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

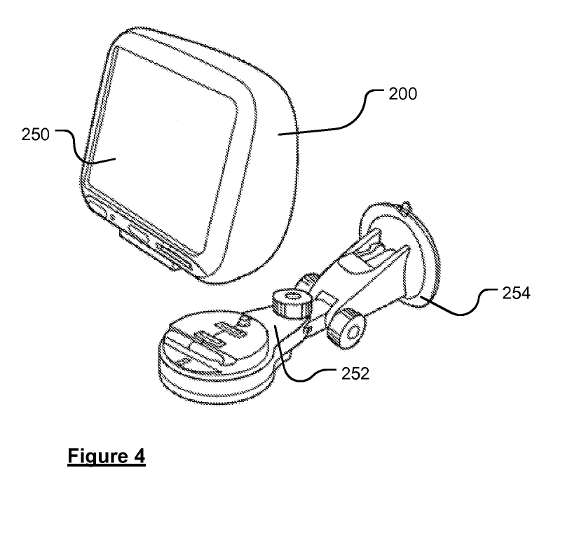

In one arrangement, one aspect of the input device 204, the touch panel, and the display screen 206 are integrated so as to provide an integrated input and display device, including a touchpad or touchscreen input 250 (FIG. 4) to enable both input of information (via direct input, menu selection, etc.) and display of information through the touch panel screen so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation device 200, the processor 202 is operatively connected to and capable of receiving input information from input device 204 via a connection 210, and operatively connected to at least one of the display screen 206 and the output device 208, via respective output connections 212, to output information thereto. The navigation device 200 may include an output device 208, for example an audible output device (e.g. a loudspeaker). As the output device 208 can produce audible information for a user of the navigation device 200, it is should equally be understood that input device 204 can include a microphone and software for receiving input voice commands as well. Further, the navigation device 200 can also include any additional input device 204 and/or any additional output device, such as audio input/output devices for example.

The processor 202 is operatively connected to memory 214 via connection 216 and is further adapted to receive/send information from/to input/output (I/O) ports 218 via connection 220, wherein the I/O port 218 is connectable to an I/O device 222 external to the navigation device 200. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile telephone for example, wherein the mobile telephone connection can be used to establish a data connection between the navigation device 200 and the Internet or any other network for example, and/or to establish a connection to a server via the Internet or some other network for example.

FIG. 3 further illustrates an operative connection between the processor 202 and an antenna/receiver 224 via connection 226, wherein the antenna/receiver 224 can be a GPS antenna/receiver for example. It should be understood that the antenna and receiver designated by reference numeral 224 are combined schematically for illustration, but that the antenna and receiver may be separately located components, and that the antenna may be a GPS patch antenna or helical antenna for example.

It will, of course, be understood by one of ordinary skill in the art that the electronic components shown in FIG. 3 are powered by one or more power sources (not shown) in a conventional manner. As will be understood by one of ordinary skill in the art, different configurations of the components shown in FIG. 3 are contemplated. For example, the components shown in FIG. 3 may be in communication with one another via wired and/or wireless connections and the like. Thus, the navigation device 200 described herein can be a portable or handheld navigation device 200.

In addition, the portable or handheld navigation device 200 of FIG. 3 can be connected or “docked” in a known manner to a vehicle such as a bicycle, a motorbike, a car or a boat for example. Such a navigation device 200 is then removable from the docked location for portable or handheld navigation use.

Referring to FIG. 4, the navigation device 200 may be a unit that includes the integrated input and display device 206 and the other components of FIG. 2 (including, but not limited to, the internal GPS receiver 224, the microprocessor 202, a power supply (not shown), memory systems 214, etc.).

The navigation device 200 may sit on an arm 252, which itself may be secured to a vehicle dashboard/window/etc. using a suction cup 254. This arm 252 is one example of a docking station to which the navigation device 200 can be docked. The navigation device 200 can be docked or otherwise connected to the arm 252 of the docking station by snap connecting the navigation device 200 to the arm 252 for example. The navigation device 200 may then be rotatable on the arm 252. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

Referring to FIG. 5, when docked in-vehicle, the navigation device 200 communicates with at least one electronic data bus 300 of the vehicle. The navigation device 200 may communicate with the bus 300 by means of an interface unit 301, either via a direct connection at the docking station, or via a wireless connection. For example, the interface unit 301 may be a wireless interface (e.g. Bluetooth interface) of the vehicle. The data bus 300 carries signals between different sensor modules 302 and control modules 304 of the vehicle, allowing the different units to communicate. The modules 302, 304 form part of the vehicle's built in systems for controlling operation of the vehicle. Non-limiting examples of the control modules may include the engine control unit (ECU) 304a, traction control module 304b, suspension and stability control module 304c, airbag control module 304d, windscreen wiper control module 304e, theft-prevention module 304f, anti-lock braking module 304g, transmission control module 304h, cruise-control module 304i, climate-control module 304j, etc. Non-limiting examples of sensor modules may include a rain-fall sensor 302a, a steering position sensor 302b, one or more suspension travel sensors 302c, an external ambient temperature sensor 302d, one or more transmission and engine performance sensors 302e, a microphone 302f, vehicle speed sensor 302g, parking-assist camera 302i, etc. The sensors may also include a dead-reckoning position sensor 302h for maintaining a running estimation of displacement of the vehicle in three-dimensional space. The data bus 300 enables information transfer between the different control units, and interrogation or receipt of information from the sensors. The data bus 300 may operate according to an established data bus protocol, such as the Controller Area Network bus (CAN-bus) protocol that is widely used in the automotive industry for implementing a distributed communications network. One or more of the sensors 302 may, as an alternative to, or in addition to, communicating via the bus 300, communicate with a respective control unit 304 via a dedicated direct connection (not shown). Such a direct connection may be used, for example, where a continuous signal from the sensor is required by the control unit, or where the signal is required to be transmitted over a secure data path. Not all sensor signals may be available from the bus 300, but the types of information used by the present embodiment are generally obtainable directly, or indirectly, via the bus 300 and/or the interface unit 301.

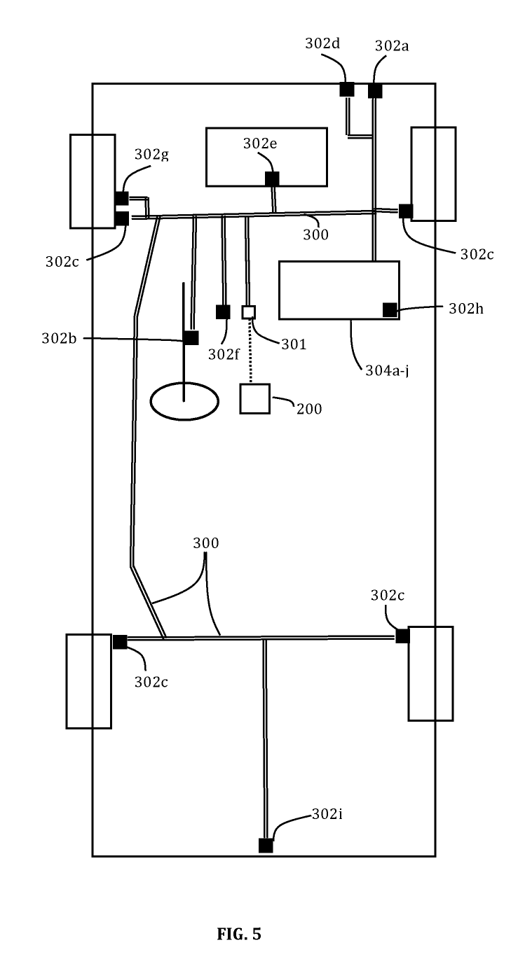

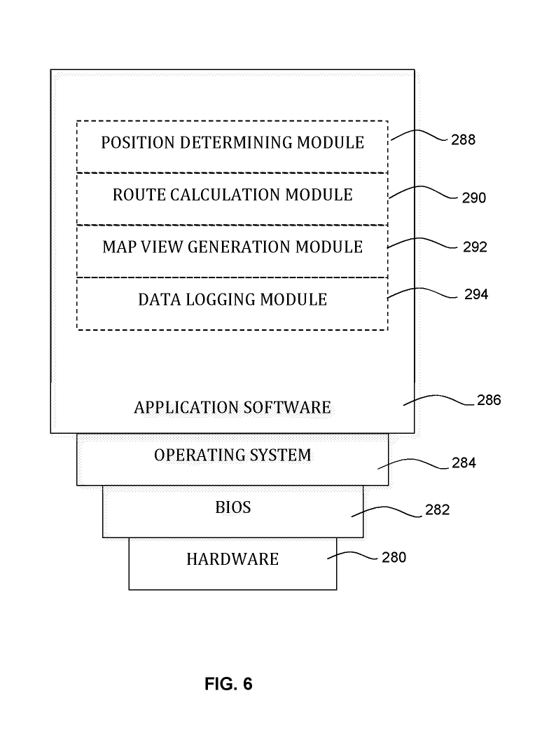

Turning to FIG. 6, within the navigation device 200, processor 202 and memory 214 cooperate to support a BIOS (Basic Input/Output System) 282 that functions as an interface between functional hardware components 280 of the navigation device 200 and the software executed by the device. The processor 202 then loads an operating system 284 from the memory 214, which provides an environment in which application software 286 (implementing some or all of the above described route planning and navigation functionality) can run. The application software 286 provides an operational environment including the GUI that supports core functions of the navigation device, for example map viewing, route planning, navigation functions and any other functions associated therewith. The application software 286 may include a position determining module 288, route planning module 290, map-view generation module 292, and data-logging module 294.

In accordance with the principles of the present invention, one of the functions of the data-logging module 294 is to monitor information on the data bus 300 of the vehicle, and to log information that may be useful for collecting supplementary road information for the digital map. The idea is that, although the sensor modules 302 of the vehicle are not intended for collecting map information and certainly would not be specifically configured for this, the information produced by some of the sensors 302 is surprisingly useful for deriving supplementary road information using statistical analysis. Sensor data logged by the navigation device is uploaded to a server 150 where data is pooled and statistical analysis carried out. The statistical accuracy is greatly increased by analysing sensor data collected from the same vehicle travelling the same route multiple times, and/or combining together data collected from different vehicles. The collective effect of multiple data sources provides surprisingly accurate supplementary road information, much greater than that envisaged possible from the types of sensor information normally available in an average vehicle.

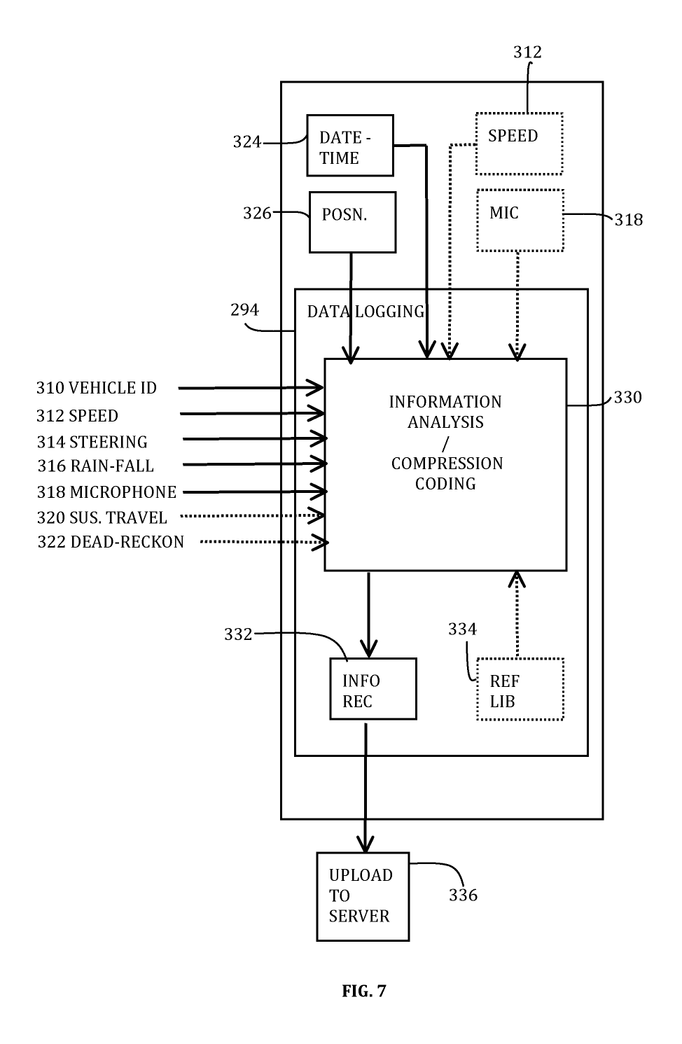

Referring to FIG. 7, the data logging module 294 accepts information inputs from at least one information source, that may be selected from:

Identification information 310 identifying the name and type of vehicle. Such information may be obtainable from the interface unit 301.

Vehicle speed 312. This information may be available from the vehicle's speed sensor 302g, and/or it may be calculated within the navigation device 200 in accordance with the rate of change of position.

Steering wheel angular position 314, available from the vehicle's steering sensor 302b.

Rain-fall detection 316, available from the vehicle's rain-fall sensor 302a.

Microphone signal 318, indicative of ambient vehicle noise. This signal may be obtained from the vehicle's microphone 302f, and/or from the navigation device's microphone if provided.
Suspension travel 320, obtainable from the vehicle's one or more suspension travel sensors 302c.

Dead reckoning position 322, obtainable from the vehicle's dead reckoning sensor 302h, if provided.

Real date and time information 324. Up to date time and date information is maintained automatically within the navigation device 200, but may also be available from the vehicle's interface unit 301.

Position information 326 obtained within the navigation device, and representing the real time position of the vehicle, and matching the position to a road on a map.

Image output from the parking-assist camera 302h, if provided.

Not all of the above information sources may be available, nor used by the navigation device. Alternatively, a greater number of information sources may be available and used by the navigation device. The above is merely a list of information sources useful for the examples described later.

The data logging module 294 comprises a first signal analysis and/or compression coding section 330 for receiving the information inputs 310-326, and a second information recording section 332. The first section 330 serves to reduce the quantity of information to a level that is recordable more efficiently by the second section. The second section 332 records the information until the recording is ready to be uploaded to the server 150 (at step 336 performed after the logging step 294). The second section 332 may form part of a trip log recording function of the navigation device. In one form, the first section 330 performs compression coding, so that the signal levels are recorded on a continuous basis, but in a compressed format. Any suitable compression coding may be used, including but not limited to, run-length coding, delta-coding, prediction coding, symbol coding. Alternatively, the first section 330 may be configured not to compress signals on a continuous basis, but instead recognise one or more patterns of interest, as identified by pattern models stored in a reference database 334. When a pattern of interest is recognized, an information “event” is generated by the first section 330, indicative of the information and signals that characterise the event. Examples are described later. Event coding may be more efficient, because only the events of interest are recorded, and this also reduces the amount of data to be uploaded later to the server. However, event coding may require a greater processing overhead within the navigation device 200.

Non-limiting examples of how the information sources 310-324 may be used to derive supplementary road information are now described. The types of supplementary road information are useful for determining road hazards, and for quantifying the safety of the road, especially in poor weather conditions. This can be used, as described later, to aid calculation of a navigation route providing a high degree of safety.

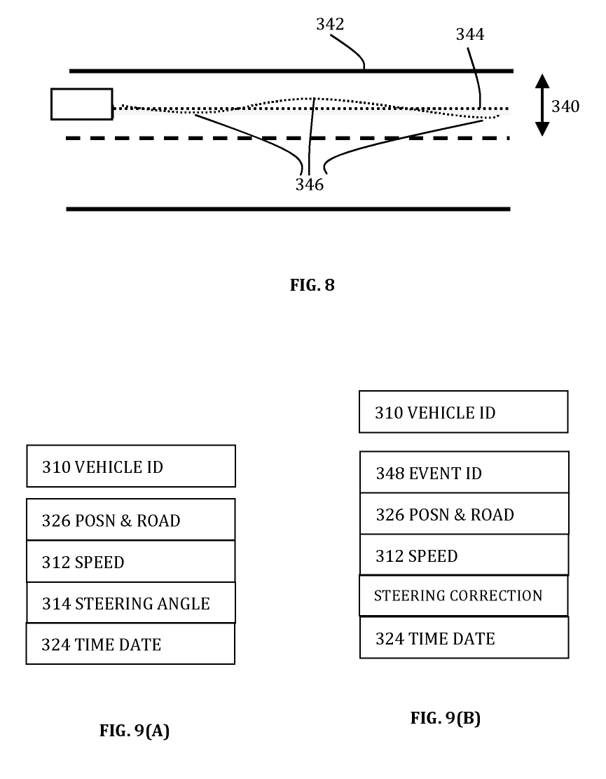

Referring to a first example shown in FIG. 8, an indication of the width 340 of a lane 342 may be obtained by analysing how a driver corrects the steering of the vehicle. Normally, a driver does not drive precisely in the centre of a lane 342, but instead tends to sway left and right of the centre-line 344 to within a margin of the lane periphery. The driver makes appropriate, usually small, corrections to the steering as the car drifts towards a lane periphery either side of the centre-line. Analysis of the steering corrections, their frequency and/or amplitude, as well as the vehicle type and speed, provides a statistical indication of the lane width 340. The statistical accuracy is very much improved by combining information obtained from multiple vehicles and/or from the same vehicle, travelling the same route.

Referring to FIG. 9(a), the one way of recording the sensor information is to compression code continuous information sources selected from: the position and road information 326; vehicle speed 312; steering angle 314; and real time and date information 324. Such information can be analysed later to identify the points 346 (FIG. 8) at which steering corrections are made via the steering wheel position. Referring to FIG. 9(b), an alternative technique is to analyse the information signals 326, 312, 314 and 324 in real time and to detect patterns of information corresponding to the points 346 at which steering corrections are made. An information “event” is generated for each steering correction point 346, the event including the characteristic information comprising one or more of: an event identifier 348 indicating the type of event (lane steering correction) and/or an event index number; the position and road information 326 at the point 346; vehicle speed at the point 346; real time and date information 324 for the point 346; and amplitude of steering correction (e.g. the angle by which the steering wheel is turned to correct the steering). Recording only events instead of continuous signals can reduce the quantity of data recorded at step 332, and simplify later processing because the significant events have already been discriminated.

The 2^{nd}-4^{th} examples below illustrate supplementary road information relating to the physical surface defining the road.

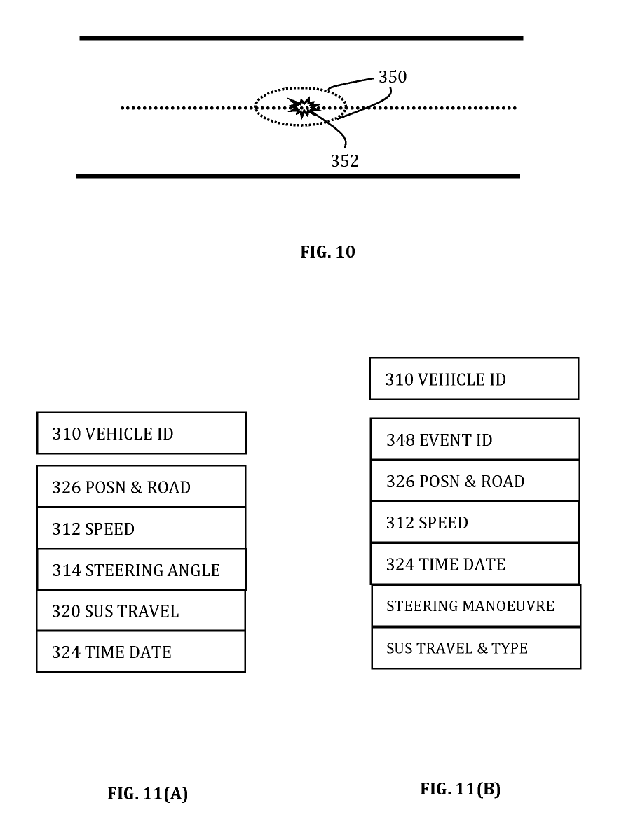

Referring to FIG. 10, the second example is the detection of driving obstacles 352 in the road surface, such as pot-holes or speed-bumps. With such obstacles, either the vehicle will traverse the obstacle, registering significant suspension travel, or the driver will manoeuvre around the obstacle 352, as illustrated by the broken lines 350. Both will normally occur at low speed, but especially the manoeuvre 352. In the case of suspension travel, two conditions may be discriminated. When traversing a speed bump, the suspension is initially compressed as the wheel rises, then extends as the wheel descends. When traversing a pot-hole, the opposite occurs. The suspension is initially extended as the wheel descends into the hole, then compresses as the wheel rises out of the hole. Also, depending on the nature of the suspension travel information 320, it may be possible to identify which of the vehicle's wheels is currently traversing the obstacle, allowing the relative position of the obstacle to be identified. The occurrence of such suspension travel or manoeuvre a single time by a single vehicle does not indicate unambiguously a speed bump or pot-hole-like obstacle. However, if different vehicles all register at the same position, either suspension travel, or steering to avoid an obstacle, this is a statistical indication of a permanent feature such as a speed-bump or pot-hole in the road. The statistical accuracy is increased the more the same vehicle travels the same road, or multiple vehicles travel the same road, each time collecting sensor data.

Referring to FIG. 11(a), one way of recording the sensor information is to compression code continuous information sources selected from: the position and road information 326; vehicle speed 312; steering angle 314; suspension travel 320; and real time and date information 324. Such information can be analysed later to identify type of obstacle or manoeuvre 350 (FIG. 10). Referring to FIG. 11(b), an alternative technique is to analyse the information signals 326, 312, 314, 320 and 324 in real time and to detect patterns of information corresponding to traversing an obstacle 352, or maneuvers 350 for avoiding an obstacle 352. An information “event” is generated for each detection, the event including characteristic information comprising one or more of: an event identifier 354 indicating the type of event (driving obstacle); the position and road information 326 at which the detection is made; vehicle speed 312; real time and date information 324; the amount of deviation around the obstacle based on the degree of steering executed by the driver; the amount and type of suspension travel. Recording only events instead of continuous signals can reduce the quantity of data recorded at step 332, and simplify later processing because the significant events have already been discriminated. In the above example, a single event type is used to detect and describe both traversing an obstacle or steering around it, and combines both steering information and suspension travel information in a single event. Alternatively, if preferred, two different and independent events could be used to detect and describe (i) steering around an obstacle, and (ii) suspension travel when traversing an obstacle. Moreover, different events could also be used to detect and describe the different types of suspension travel when (i) traversing a pot-hole, and (ii) traversing a speed-bump.

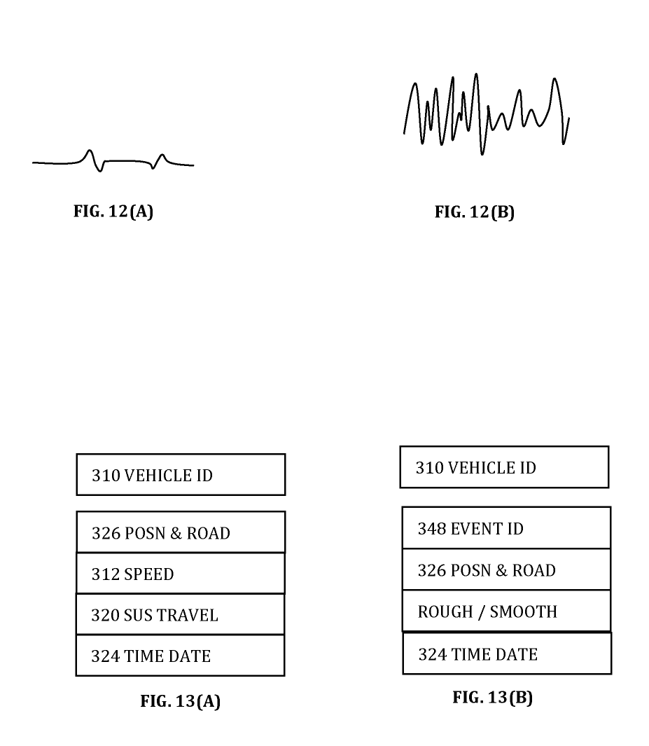

Referring to FIGS. 12a and b, the third example of supplementary road information is the condition of the road, whether smooth or rough. A smooth surface generally indicates a paved surface (for example with asphalt, tarmac, or other finished paving). A non-smooth surface generally indicates a surface of bricks or unpaved (for example, a rough or dirt road). Such information is derivable from the suspension travel information input 320 obtained from the suspension travel sensor(s) 302c. Referring to FIG. 12(a), a smooth road is generally indicated by a smooth signal with occasional spikes as the suspension moves to accommodate occasional bumps. Referring to FIG. 12(b), an unpaved road is generally indicated by a non-smooth signal, resulting from near continuous movement of the suspension to as the vehicle moves over the rough unpaved surface. A similar information pattern is also generated by a dead-reckoning sensor, although the signal is then a result of the vehicle motion as the vehicle bounces over a rough surface road. Again, the statistical accuracy is greatly improved the greater the number of times a vehicle travels the same road, or multiple vehicles travel the same road, and each time collect sensor data.

Referring to FIG. 13(a), one way of recording the sensor information is to compression code continuous information sources selected from: the position and road information 326; vehicle speed 312; suspension travel 320 (and/or dead reckoning information 322); and real time and date information 324. Such information can be analysed later to identify the whether the road surface corresponds to a smooth or rough surface. Referring to FIG. 13(b), an alternative technique is to analyse the information signals 326, 312, 320/322 and 324 in real time and to detect patterns of information corresponding to the different road surface conditions. An information “event” is generated each time that the road surface condition changes significantly, and/or when ever the vehicle moves from one road on the map to another road. The event includes characteristic information comprising one or more of: an event identifier 354 indicating the type of event (smooth/rough road surface condition); the position and road information 326 at which the detection is made; vehicle speed 312; real time and date information 324; and type of road surface (smooth or rough). Recording only events instead of continuous signals can reduce the quantity of data recorded at step 332, and simplify later processing because the significant events have already been discriminated.

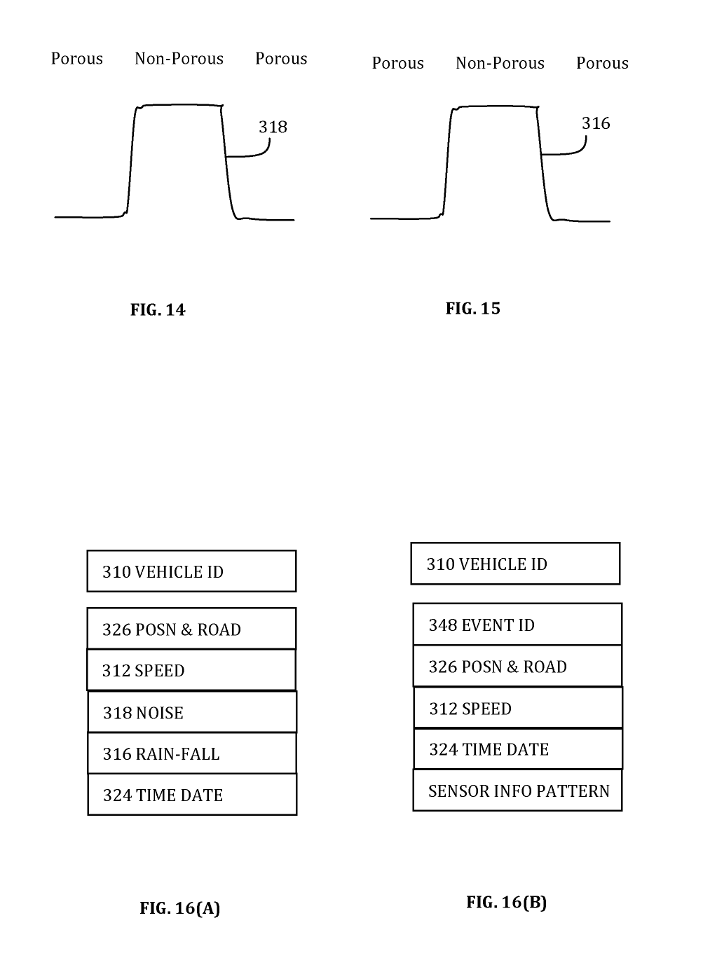

Referring to FIGS. 14 and 15, the fourth example of supplementary road information is whether, in the case of a paved road, the paving is a non-porous or porous. An example of non-porous paving is traditional tarmac. In the event of rain, water does not generally penetrate the surface, and instead flows on top of the road surface to surface drains. An example of a porous paving is porous tarmac, which has voids between particulate matter to permit rain water to penetrate below the road surface. This is considered to aid drainage and reduce the risks of standing water pooling on the road surface. While the sensor information might not directly indicate whether the current road surface is porous or non-porous, it is nevertheless possible to detect when a vehicle traverses from one road type to another. Referring to FIG. 14, one indication is provided by the amount of ambient rolling noise of the vehicles tyres, obtained from the microphone signal 318. The rolling noise is significantly reduced when travelling on a porous road surface, because the voids in a porous surface absorb some of the noise. A significant abrupt increase in the ambient road noise without an increase in vehicle speed (and/or engine speed) may be an indication that the vehicle has traversed from porous to non-porous paving. Conversely, a significant abrupt decrease in the ambient road noise without a decrease in vehicle in speed (and/or engine speed) may be an indication that the vehicle has traversed from non-porous to porous paving. The accuracy of this indication is increased if the same characteristic is observed multiple times (e.g. from other vehicles, or from the same vehicle at a later time) passing the same point on the road.

Referring to FIG. 15, another indication may be the amount of rain detected by the rain-fall sensor 302a, in the case that the rain-fall sensor 302a is of a type responsive to road spray. The quantity of surface water that collects on the road surface is generally greater for non-porous paving, and this may result in significantly greater spray as the water is thrown up from the road surface by vehicles' tyres. A significant abrupt increase or decrease in detected rain may indicate traversing from porous to non-porous paving, or from non-porous to porous paving, respectively. The accuracy of this indication is vehicle has traversed from non-porous to porous paving. The accuracy of this indication is increased if the same characteristic is observed multiple times (e.g. from other vehicles, or from the same vehicle at a later time) passing the same point on the road.

Another indication may be the speed of the vehicle in association with either an abrupt change in detected noise and/or rain as described above. It is observed that, when traversing from non-porous paving to porous paving, drivers tend to increase speed gradually, as the amount of surface water on the road decreases, and the driver perceives better driving conditions.

Referring to FIG. 16(a), one way of recording the sensor information is to compression code continuous information sources selected from: the position and road information 326; vehicle speed 312; ambient noise 318; detected rainfall 316; and real time and date information 324. Such information can be analysed later to identify one or more if the above information patterns corresponding to traversing between porous and non-porous road paving. Referring to FIG. 16(b), an alternative technique is to analyse the information signals 326, 312, 320/322 and 324 in real time and to detect patterns of information corresponding to the different road surface conditions. An information “event” is generated each time that one of the above information patterns is detected indicative in a change between porous and non-porous road paving. The event includes characteristic information comprising one or more of: an event identifier 354 indicating the type of event (porous/non-porous paving); the position and road information 326 at which the detection is made; vehicle speed 312; real time and date information 324; and the detected information pattern. Recording only events instead of continuous signals can reduce the quantity of data recorded at step 332, and simplify later processing because the significant events have already been discriminated.

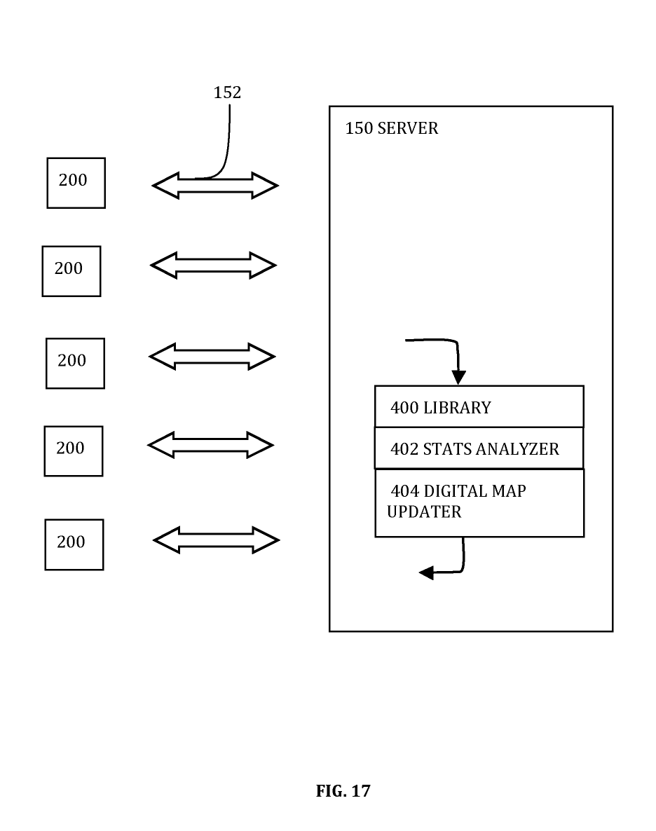

Referring to FIG. 17, the server 150 receives the data logged by multiple navigation devices 200, by communicating with the navigation devices over respective communications channels 152. As explained previously, there are a variety of possibilities for a navigation device 200 to communicate. One typical technique is to connect the navigation device 200 to a user's home computer or PC, and to use the computer's internet connection to establish communication with the server 150. During such a connection, the logged data is uploaded to the server 150 (step 336 in FIG. 7). Updates for the digital map used by the navigation device 200 are downloaded from the server, to keep the digital map up to date, and any software or firmware updates for the navigation device can also be downloaded from the server 150. Certain components of the server 150 have already been described with respect to FIG. 2. These components function to define processing resources in the form of a library 400 for storing the logged data received from multiple devices, a statistical analyzer 402 for analyzing the collection of logged data in the library 400 to identify information patterns that provide a reliable indication of supplementary road information, and a digital map updater 404 for updating the digital map with the new supplementary road information. The supplementary road information be integrated with the digital map, or it may form part of a separate information component for use with the digital map. The updated digital map, or components thereof, are subsequently downloaded to navigation devices 200 (usually at a later time, or in a subsequent communications session).

A highly advantageous feature of this embodiment is that the server receives information automatically from the navigation devices 200. The more frequently that users use their navigation devices in their vehicles, and connect to the server 150 for updating, the greater the quantity of information provided to the server, and the more accurate is the supplementary road information inferred by the analyzer 402. This enables supplementary road information to be obtained and kept up to date, even in the absence of specially equipped mapping vehicles.

The combination of lane width information, speed information, and other supplementary road information can enable the type of road to be deduced, for example, motorway, through road, local destination road, etc.

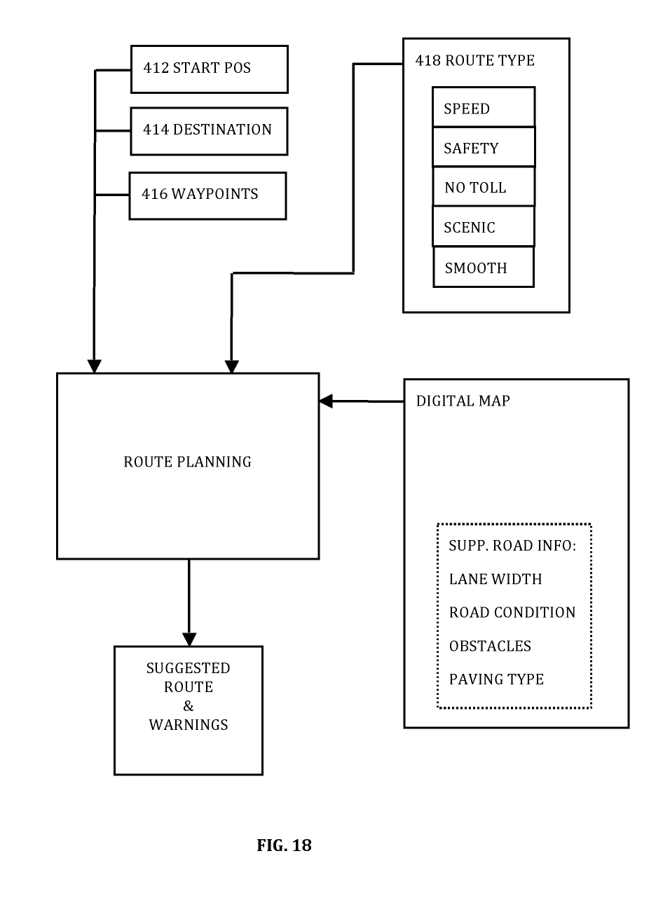

FIG. 18 illustrates schematically selected information inputs for a route calculation algorithm 410 that may be used in, for example, the navigation device 200. The information inputs include a start (or current) position/address 412, a destination position/address 414 at which the driver desires to arrive, and one or more waypoints 416 that the driver desires to visit en route. The inputs further include a selection 418 of the primary factor(s) for calculation of the route. Examples include optimum speed (to arrive at the destination quickly), safety (to minimise accident risk, especially in poor weather), toll-free (for avoiding toll roads), scenic (for finding a route with scenic views or passing points of interest), and smooth (for avoiding rough roads, or roads with speed-bumps or pot-holes that result in accelerated wear of the vehicle). The information inputs further include components of the digital map for performing the route calculation, including the supplementary road information.

The supplementary road information is especially useful for (i) warning a driver of road obstacles and hazards, and (ii) quantifying the safety of a road, to enhance route calculation when a driver desires a safe route. For example, the lane width provides one indication of safety. A wider road may be generally equated to a safer road, as there is less risk of vehicle contact, and more room to manoeuvre while driving. A smooth road is likewise safer than a rough road, and may be more suitable for general-purpose vehicles. A porous paved road may be safer than a non-porous paved road in case of heavy rain, because a porous road provides better drainage away from the road surface and reduces the amount of standing water on the road surface that could otherwise be an aquaplaning risk for vehicles. The avoidance of obstacles or hazards such as pot-holes likewise increases safety, especially as such hazards may be of limited visibility in poor weather. Such information may be used in combination with other safety-related information, such as the location of schools and religious centres, where there is risk of high pedestrian density.

Additionally, or alternatively, the information regarding road obstacles and hazards, and the information regarding road condition, is useful for finding a smooth route.

Weather forecast information may also be combined in order to judge which roads might be safest. A pre-trip warning may be generated of potential driving safety issues, obstacles and hazards.

If a vehicle includes a camera, such as the parking-assist camera 302i, the camera output may also be used by the data logging module 294. Having identified a signal pattern of interest based on other sensor output information, the camera image can be captured and recorded by the data logging module 294. The image may be later uploaded to the server 150 to aid information analysis. Additionally or alternatively, the server 150 may configure the navigation device with a list of one or more roads of interest to be filmed should the navigation device detect that it's position coincides with one of the roads of interest.

In addition to route-planning, the ability to detect reliably the occurrence of pot-holes in roads enables such information to be provided, on a commercial basis if appropriate, to companies or organisations responsible for road maintenance.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation apparatus for in-vehicle use, the apparatus comprising:
a processing resource operably coupled to a data store, the data store comprising data representing a digital map;
a location determination unit operably coupled to the processing resource and capable of determining a location;
a vehicle communications interface for communicating with an in-vehicle data system for carrying sensed information obtained from at least a steering position sensor for sensing an angular position of the vehicle steering control;
a server communications interface for communicating with a server; wherein the processing resource is configured to:
(i) receive via the vehicle communications interface, the sensed information indicating an angular position of steering;
(ii) selectively store, into the data store, information obtained from the sensed information, and the position of the vehicle corresponding to the occurrence of sensed information as determined by the location determining unit; and
(iii) selectively output the logged information to the server communications interface for uploading to a server for determining lane width.

2. The navigation apparatus of claim 1, wherein the processing resource is further operable to store information indicating vehicle speed corresponding to the occurrence of said sensed information.

3. The navigation apparatus of claim 2, wherein the vehicle speed is obtained, via the vehicle communications interface, from a speed sensor of the vehicle.

4. The navigation apparatus of claim 2, wherein the vehicle speed is obtained by calculation of the rate of change of position determined by the location determination unit.

5. The navigation apparatus of claim 1, wherein the navigation device is a portable navigation device, and wherein the vehicle communications interface is a wireless interface.

6. The navigation apparatus of claim 1, wherein the processing resource is configured to analyse the sensed steering position information, determine the occurrence of in-lane steering corrections, and store information defining each occurrence of an in-lane steering steering correction.

7. Apparatus for communicating with plural navigation devices that are usable in vehicles, the apparatus comprising:
a processing resource operably coupled to a data store, the data store comprising data representing digital map information for uploading to a navigation device;
a communications interface for communicating with navigation devices and configured for downloading information to the navigation devices and uploading information from the navigation devices;
wherein the processing resource is configured to:
receive from at least one navigation device stored information representative of steering of the vehicle while driving, and the corresponding vehicle position at the time of the steering; and
analyse said information statistically to determine therefrom an estimated lane width of the road used by the vehicle.

8. The apparatus of claim 7, wherein the stored information further comprises information representative of vehicle speed at the time of steering, and wherein the processing resource is configured to determine the lane width based on one or more of: the frequency of repetition of steering corresponding statistically to in-lane steering corrections, the amplitude of steering corresponding statistically to in-lane steering corrections, vehicle speed.

9. The apparatus of claim 7, wherein the processing resource is configured to receive said stored information as a stream of sampled data representing a continuous record of steering.

10. The apparatus of claim 7, wherein the processing resource is configured to receive said stored information as a sequence of information events, each event correspond to a change in vehicle steering.

11. The apparatus of claim 7, wherein the processing resource is further configured to combine statistically the information received from plural navigation devices.

12. A method of operation of a navigation device for in-vehicle use, the method comprising:
performing location determination to determine a location of the navigation device;
establishing communication between the navigation device and an in-vehicle data system for carrying sensed information obtained from at least a steering position sensor for sensing an angular position of the vehicle steering control;
receiving the sensed information indicating an angular position of steering;
selectively storing, during at least one vehicle journey, information obtained from the sensed information, and the position of the vehicle corresponding to the occurrence of sensed information as determined by the location determining step;
establishing communication between the navigation device and server apparatus; and
selectively outputting the stored information to the server for determining lane width using the outputted information.

13. A method of operation of apparatus for communicating with a plurality of navigation devices, the method comprising:
establishing communication with at least one of the plural navigation devices;
receiving from said at least one navigation device stored information representative of steering of the vehicle while driving, and the corresponding vehicle position at the time of the steering; and
analysing said information statistically to determine therefrom an estimated lane width of the road used by the vehicle.

14. The method of claim 13, wherein the step of analysing comprises analyzing information from plural navigation devices having information for at least one road in common.

15. A computer program element comprising computer program code, which when executed by a processor resource, causes the processor resource to implement a method as defined in claim 12.

16. A computer program element as claimed in claim 15, embodied on a computer readable medium.

17. A method of determining lane width of a road, the method comprising: providing a plurality of navigation devices for in-vehicle use, each navigation device being configured to store information obtained from a steering sensor of a respective vehicle representing steering of the vehicle while on the road;
receiving the stored information from the plurality of navigation devices; and
analyzing the received information statistically to determine, from the characteristics of in-lane steering corrections, a value of lane width for said road.
